(19) United States
(12) Patent Application Publication
(10) Pub. No.: US 2012/0210639 A1
(43) Pub. Date: Aug. 23, 2012

(54) VASE AND INSERT ASSEMBLY FOR HOLDING FLOWERS, FLAGS, BALLOONS, AND THE LIKE

(76) Inventor: Cindy Cover, La Vernia, TX (US)

(21) Appl. No.: 13/402,417

(22) Filed: Feb. 22, 2012

Related U.S. Application Data
(60) Provisional application No. 61/445,377, filed on Feb. 22, 2011.

(51) Int. Cl. A01G 5/00; A47G 7/06

(52) U.S. Cl. 47/41.13; 248/27.8

(57) ABSTRACT

An insert for a vase, the insert for receiving the stem of an ornament, such as a flower. The insert has a cylindrical base member that is of a diameter smaller than the inner diameter of the vase and has fins or ribs extending outward therefrom such that the ribs interfere and bend when the insert is inserted into the vase. The insert is made of a pliable or elastomeric material and the base member has channels adapted to receive stems thereinto.

This is a patent application that claims the benefit of priority from U.S. Provisional Patent Application Ser. No. 61/445,377, filed Feb. 22, 2011.

### FIELD OF THE INVENTION

Vase and insert assemblies, more specifically, a vase and insert assembly comprising an elastomeric, foam-free, particulate-free, insert in an OEM vase.

### BACKGROUND OF THE INVENTION

Vase and insert assemblies are known in the art. They are often used at graveyards for placing flowers, flags, balloons or the like adjacent the grave of a loved one.

Typical prior art vase and insert assemblies comprise a vase made of a durable substance, such as heavy plastic, metal or glass, typically in the range of about 2 to about 10 inches high. The typical prior art vase receives a foam or particulate insert. The foam inserts are shaped to fit in the lower portion of the inner volume defined by the vase, frictionally engaging the inner walls thereof. The foam breakably receives the stem of a flag or a flower, to provide stability to the flag or the flower within the vase. The foam insert will hold the stems generally vertically within the inner volume of the vase with the stems engaging the foam and the foam engaging the base to provide some stability to the flower, insert, and vase combination.

Particulate matter, such as an assemblage of pebbles or the like, may fill up the lower portion of an inner volume of a vase. Stems, flags or the like may then be inserted into the particulate matter to provide stability for the object within the vase.

Both of these prior art methods for achieving stability of an elongated member within a vase are, at least initially, satisfactory. Moreover, they are fairly inexpensive to make and assemble. However, over time, the foam based insert will degenerate due to exposure to the elements. This can cause quite a mess, as the foam itself breaks up and small chunks can scatter about a gravesite creating an unsightly situation. On the other hand, particulate matter can easily spill out of the vase, especially one that is overturned. As with the foam, spilled particulate or foam chunks can help destroy an otherwise peaceful setting desired at a gravesite or in a cemetery.

Much time has been spent by the cemetery workers cleaning up foam chunks and particulate matter from gravesites. This time makes the landscaping and presentation of a cemetery more expensive.

There exists a need for a vase and insert assembly that achieves stability for elongated members engaged therewith; that is to say, there is a need for providing a durable insert and vase assembly, wherein the insert is capable of snugly receiving a vertical, elongated support member, such as a flower stem or a flagpole.

### SUMMARY OF THE INVENTIONS

An insert for a vase, the insert for receiving the stem of an ornament, such as a flower. The insert has a cylindrical base member that is of a diameter smaller than the inner diameter of the vase and has fins or ribs extending outward therefrom such that the ribs interfere and bend when the insert is inserted into the vase. The insert is made of a pliable or elastomeric material and the base member has channels adapted to receive stems thereinto.

Applicant provides, in a preferred embodiment, a thermal plastic elastomer adapted to be inserted into or engaged with a vase. The insert has a cylindrical top member with a multiplicity of stem receiving holes therein, typically the holes having a diameter of less than the stem they are intended to hold.

A cylindrical base, typically having a diameter smaller than the diameter of the top member, extends vertically downward from a lower surface of the top member. The base includes a multiplicity of channels therein, each channel in communication with one each of the multiplicity of stem receiving holes in the top member.

The base is finned, having a multiplicity of fins extending outward from the typically cylindrical surface thereof, typically with the removed end such that it is less than the diameter of the top member. The fins have a relatively narrow root thickness compared to their width and therefore provide some flexibility. The fins are dimensioned to receive the inner walls of the stem in frictional engagement therewith, typically folded over or bent somewhat, so as to provide both frictional component and an elastic component for maintaining the insert within the base,

### BRIEF DESCRIPTION OF THE DRAWINGS

FIG. 1 illustrates a side perspective view of Applicant's vase and insert assembly holding the stems of flowers therein.

FIG. 2 illustrates the insert of Applicant's device in a side perspective view, with the vase removed therefrom.

FIG. 3 illustrates a top elevational view of the insert of Applicant's assembly.

FIG. 3A illustrates a top elevational view of the insert of Applicant's assembly with cut perimeters in holes.

FIG. 4 illustrates a bottom perspective view o he insert of Applicant's vase and insert assembly.

FIG. 5 is a side perspective view showing the side and bottom of the insert.

FIG. 5A is a side perspective view of an alternate embodiment of Applicant's device.

FIG. 6 is a top elevational cross-sectional view of the insert illustrating the manner in which the fins may bend to help stabilize the insert with respect to the inner walls of the vase.

FIG. 6A is a cross-sectional view of one way in which the top member engages the base member.

### DETAILED DESCRIPTION OF THE PREFERRED EMBODIMENTS

Applicant is seen to provide a vase and insert assembly 10. Vase and insert assembly 10 is comprised typically of an OEM or standard off-the-shelf vase 12 along with Applicant's insert 14. That is to say. Applicant's insert 14 is designed and configured, as more fully set forth herein, for receipt into a standard vase, such as those supplied by Thompson Monuments, 5″×9″ turned vase; BSS Granite Monument, code M-vase01; and Eaton Brothers Corp., Lifetime vase.

Applicant's insert 14 is typically comprised of one-piece molded Sanoprene® polyethylene or other suitable material, which may be elastomeric. It is designed to frictionally and typically compressively engage the inner walls of the lower surface of an OEM or other vase, as set forth in more detail herein. Vase 12 is seen to have an inner volume 12a and an upper perimeter 12b. Vase 12 may have a height of H, typically in the range of about 4 to about 6 inches. The diameter across the upper perimeter 12b of the vase 12 may be in the range of about 2 to about 6 inches.

Turning now to insert 14, it is seen to generally comprise a disc-shaped top member 16. Top member 16 is seen to have top surface 16a, a bottom or lower surface 16c, and an outer perimeter 16b, between the two spaced apart planar circular top and bottom surfaces 16a/16c. A base member 18 is seen to be generally cylindrical, with a diameter typically smaller than the diameter of the top member 16. Base member 18 is integrally engaged to and typically molded with top surface 16a. Base member 18 has a lower surface 18a at the removed and spaced apart from where base member 18 engages top member 16.

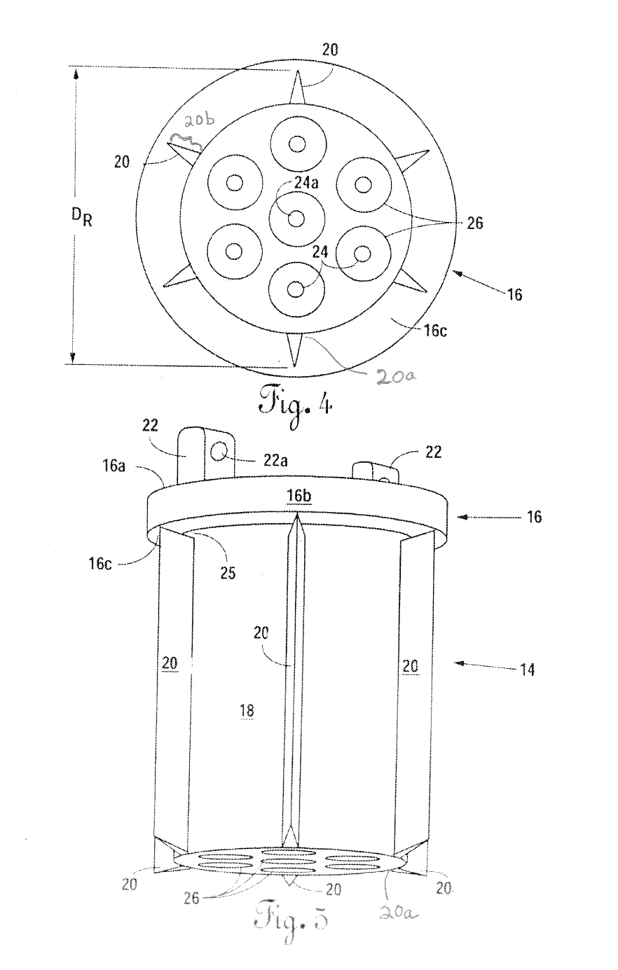

Radially spaced from the cylindrical outer walls of base member 18 is a multiplicity, typically of between about 3 to about 9 of ribs 20. It is seen that lower surface 18a of base member 18 includes channels 26 (see FIG. 4). FIG. 4 illustrates that channels 26 are open to and communicate with expandable receiving holes 24/24a that are provided in the top member 16 for receiving stems or support members therethrough.

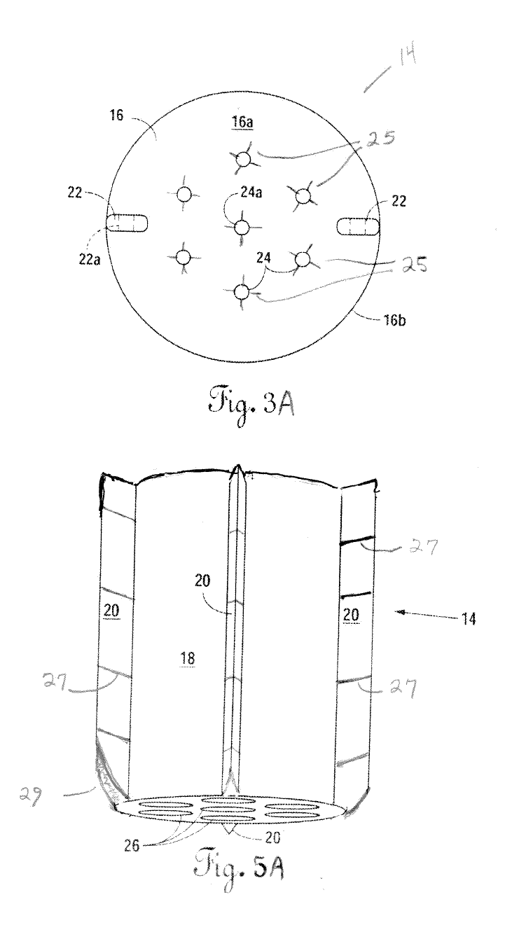

For example, it may be seen in FIG. 3 that there are six expandable receiving holes 24 in top member 16. Moreover, the pattern of the six is equi-angular about a centrally located receiving hole 24a. Typically, the circumferentially spaced receiving holes 24 are equidistance about halfway between the central receiving hole 24a and the perimeter 16b of top member 16.

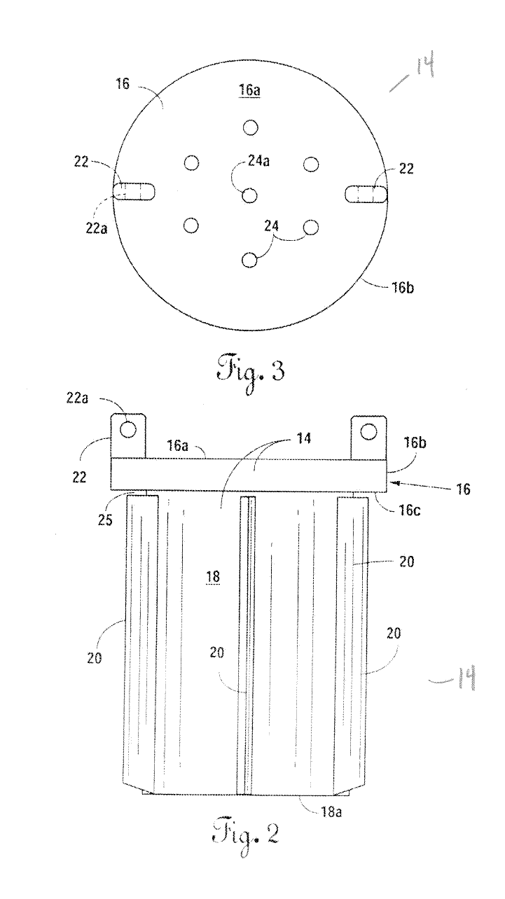

Turning back to FIG. 2, it is seen that a multiplicity of ribs or fins 20 are spaced trending longitudinally downward and there may be, for example, preferably six ribs. These ribs are flexible and typically do not join the lower surface 16c of top member 16. Instead, there is a small gap 25 between lower surface 16c and ribs 20. Ribs 20 have a root thickness 20a and width 20b, 20b>>20a by at least about 3:1. This provides flexibility. This flexibility allows ribs to bend or fold when insert 14 is placed in vase 12 as seen in FIG. 6.

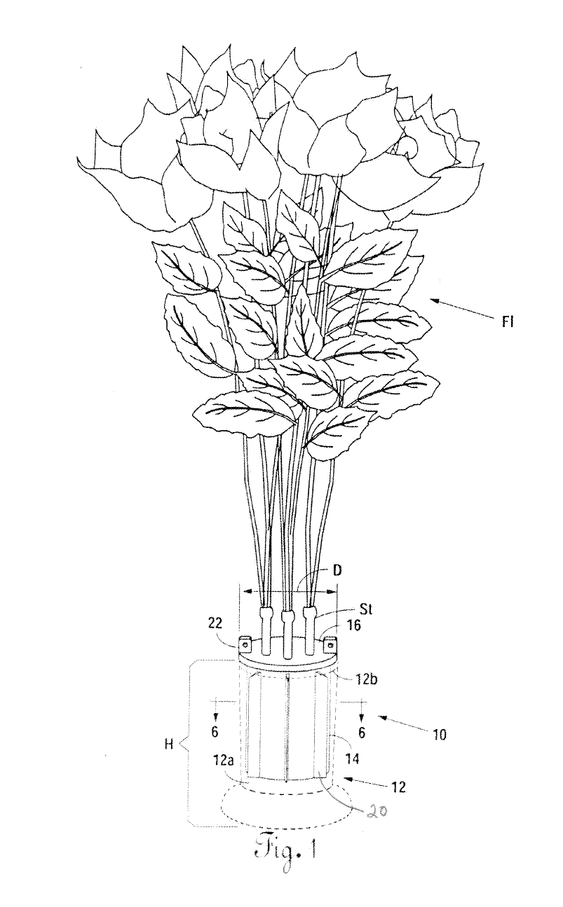

Part of the novelty and advantages of Applicant's design come from the pliability and/or elastomeric nature of both ribs or fins 20 and expandable receiving holes 24/24a. In the former, flexibility lies in both the geometry of the ribs and the pliable nature of the material. Likewise, in the latter, while the diameter of each of the holes may be in the range of about ⅛-¼ inch, the expandable material is capable of receiving stems ST, typically up to two or three times the at rest diameter and to fixedly retain them in a generally vertical position as best seen in FIG. 1.

In a preferred embodiment, the diameter of channels 26 is approximately the same as the reasonable expandable limits of receiving holes 24/24a, such expandable limit being expandable without rupture. Thicknesses for top member 16 may be about ¼ inch or preferably in the range of about ⅛ to ⅜ inches, so as to assist in providing sufficient vertical support to stems. The term “self-healing” or “self-sealing” may be used for expandable receiving holes 24/24a, wherein they substantially expand, with insertion of a stem therein, to at least about twice their diameter and wherein they retract to their original size upon removal of the stem therefrom.

As can be seen in FIG. 1, the diameter of the top of vase 12 is typically less than the diameter of top member 16. Thus top member 16 will rest on or near the upper perimeter of the vase. Moreover, at least a part of the inner volume is typically less than the diameter across the tips of the ribs or fins 20 as seen in FIG. 4. This geometric arrangement allows the underside 16c to be supported vertically on the top perimeter of vase 12, while fins or ribs with their thin geometry will bend or fold over for more secure engagement with the inner walls of vase 12. Applicant also provides balloon (or other device) engaging bosses 22, hereto, which are generally rectangular and project upward from adjacent the outer perimeter of the top surface of top member 16. These may include a hole 22a therethrough. The function of these is to tie off balloons by threading the balloon line through the hole and tying it off. Balloons are typically filled with helium and will float away unless secured. Typically vases don't include secure engagement means, so Applicant provides the same, in conjunction with the ability to support stems or the like as set forth herein.

There are a number of suitable materials that may provide sufficient elasticity for use in a preferred embodiment of Applicant's present invention. Elastomeric rubber may be used in the construction of insert 14. A more preferred elastomeric rubber is thermal plastic elastomer (TPE), and a most preferred is the thermal plastic elastomer known as Sanoprene®. Another material a bit stiffer than Sanoprene® is polyethylene.

The single hole in the center 24a and the surrounding six holes 24 provide for the availability to put a single stem in the center, three in line or four at corners of a rectangle.

The dimensions set forth below are generally applicable to a small, medium, and large base as indicated. The dimensions and number and arrangement of holes may vary.

| | Diameter of | Length of | Number of | Arrangement |
|---|---|---|---|---|
| | Top Member | Base | Holes | of Holes |
| Small | about 3″ | about 3″ | 7 | 1 × 6 |
| Medium | about 4″ | about 3″ | 7 | 1 × 6 |
| Large | about 5″ | about 3″ | 7 | 1 × 6 |

Fins 20 may have a root thickness of 20a and a width 20b. The tip or outer edges of the ribs come out to about the edge of top member 16 in one embodiment. In other embodiments, ribs may extend beyond or not reach the perimeter. Diameter D_{R} (see FIG. 4) is the maximum diameter across the widest points of opposing ribs and is sufficient to engage the inner walls of the vase at least at some point. For odd numbers of ribs, non-opposed, two times the radius from the center of top member 16 to the outer tip of a rib is generally sufficient to engage at least some interior walls of the vase in a bending or flexing manner. Thus, 2 R is usually at least about ½ inch greater than the narrowest diameter of the inner walls of the vase. The ribs are typically set equiangular about the base.

FIG. 3A illustrates that walls adjacent the perimeter of holes 24/24a may be sliced, typically radially, all the way down to the channel These cuts 25 provide flexibility so adjacent walls may grasp the members insert thereinto. Cuts 25 are especially helpful when stiffer materials, such as polyethylene, are used.

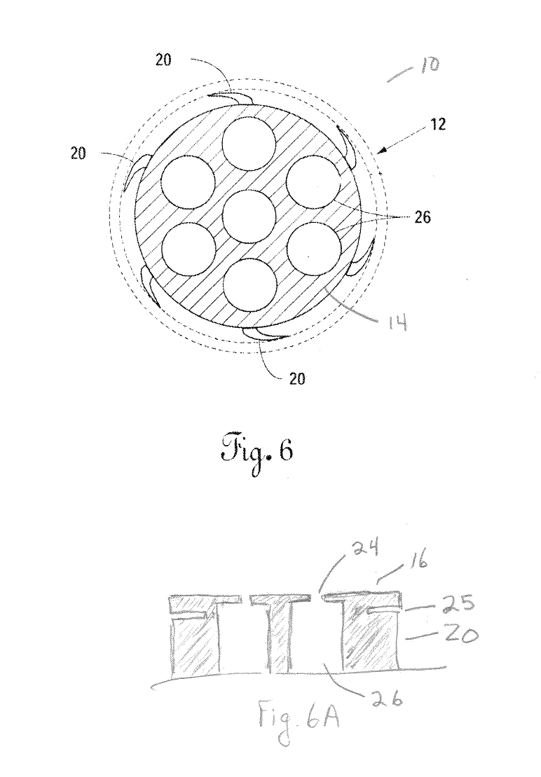

FIG. 5A illustrates that transverse cuts 27 or gaps may be made across the longitudinal axis of ribs 20 so as to assist in bending. FIG. 5A also illustrates that, in an alternate embodiment, the top of the base member may form the top of the insert 14 with channels receiving stems directly. FIG. 5A also illustrates that ribs 20 may have a longitudinally tapered portion 29 for ease of insertion into the vase.

FIG. 6A illustrates the manner in which channels 26 may extend up into top member 16. As can be seen in FIG. 6, insert 14 is dimensioned so that ribs 20 bend when encountering at least some of the interior walls of the vase. It is seen that in a preferred embodiment, ribs are tapered from root to tip (other shapes, such as rectangular, may be used), for ease of insertion into vase. While the top and base are shown to be cylindrical, any suitable shape may be used, including polygonal. The diameter of the base will typically be less than the narrowest portion (smallest diameter) of the inner walls of the base and the diameter of the insert including the ribs will be greater than the narrowest portion of the inner walls.

Although the invention has been described in connection with the preferred embodiment, it is not intended to limit the invention's particular form set forth, but on the contrary, it is intended to cover such alterations, modifications, and equivalences that may be included in the spirit and scope of the invention as defined by the appended claims.

1. A vase and insert assembly for receiving the stem of a flower or other ornamental device, the vase and insert assembly comprising:
a vase having an inner volume defined by inner walls;
an insert having a generally cylindrical top member, the top member having a multiplicity of holes and a generally cylindrical base extending therefrom, the base having a multiplicity of ribs extending radially outward therefrom, the ribs configured to engage at least some of the inner walls of the vase in bending relation, the base having a multiplicity of channels, each channel engaging a hole in the top member.

2. The vase and insert assembly of claim 1, wherein the ribs are laterally tapered.

3. The vase and insert assembly of claim 1, wherein the ribs are tapered longitudinally.

4. The vase and insert assembly of claim 1, wherein the insert is made from an elastomeric material.

5. The vase and insert assembly of claim 1, wherein the insert is made from polyethylene.

6. The vase and insert assembly of claim 1, wherein the insert is made from a thermal plastic.

7. The vase and insert assembly of claim 1, wherein the holes of the top member have cuts in walls adjacent thereto.

8. The vase and insert assembly of claim 1, wherein the holes of the top member are smaller than the stem of the flower or other ornamental device.

9. The vase and insert assembly of claim 1, wherein the channels have a diameter greater than the diameter of the holes.

10. The vase and insert assembly of claim 1, wherein the top member includes at least one boss engaged therewith.

11. The vase and insert assembly of claim 1, wherein the top member is dimensioned to engage the inner walls of the vase.

12. The vase and insert assembly of claim 1, wherein the ribs are laterally tapered, wherein the holes of the top member are smaller than the stem of the flower or other ornamental device, wherein the channels have a diameter greater than the diameter of the holes, wherein the top member includes at least one base engaged therewith, and wherein the top member is dimensioned to engage the inner walls of the vase.

13. The vase and insert assembly of claim 12, wherein the insert is made from an elastomeric material.

14. The vase and insert assembly of claim 12, wherein the insert is made from polyethylene.

15. The vase and insert assembly of claim 12, wherein the insert is made from a thermal plastic.

16. An insert for a vase, the vase having inner walls, the inner walls having a minimum inner diameter, the insert comprising:
a generally cylindrical base member having a diameter less than the minimum inner diameter of the vase and a top member on an upper surface of the base, the top member configured to engage the inner walls, the top member having a multiplicity of holes;
a multiplicity of bendable ribs engaging the base member and set equiangular and directed outward from the base member, the ribs dimensioned to engage the inner walls and bend when the cylindrical base member is inserted into the vase; and
a multiplicity of channels in the base for engaging the holes of the top surface.
